(19) United States
(12) Patent Application Publication
(10) Pub. No.: US 2015/0084546 A1
(43) Pub. Date: Mar. 26, 2015

(54) Dimming Control System

(71) Applicant: Toshiba Lighting & Technology Corporation, Yokosuka-shi (JP)

(72) Inventor: Hiroki Kubo, Yokosuka-shi (JP)

(73) Assignee: Toshiba Lighting & Technology Corporation, Yokosuka-shi (JP)

(21) Appl. No.: 14/200,048

(22) Filed: Mar. 7, 2014

(30) Foreign Application Priority Data
Sep. 20, 2013 (JP) 2013-195741

(51) Int. Cl. H05B 37/02

(52) U.S. Cl. CPC H05B 37/0245; H05B 37/0227
USPC 315/309; 315/307

(57) ABSTRACT

According to one embodiment, a dimming control system includes a luminaire and a host equipment. The luminaire receives dimming data transmitted using data frames based on a specified communication protocol, and performs dimming control of a lighting load. The host equipment uses the data frames to transmit the dimming data, and uses a part of the data frames to transmit a command to request luminaire information of the luminaire.

### INCORPORATION BY REFERENCE

The present invention claims priority under 35 U.S.C. §119 to Japanese Patent Application No. 2013-195741 filed on Sep. 20, 2013. The content of the application is incorporated herein by reference in their entirety.

### FIELD

Embodiments described herein relate generally to a dimming control system to perform dimming control of a luminaire.

### BACKGROUND

Hitherto, there is a dimming control system to perform dimming control of a luminaire for a stage, a studio or the like. In this dimming control system, a host equipment transmits dimming data in order to obtain a directed lighting state as stage lighting, and a luminaire receiving the dimming data performs dimming control of a lighting load.

The communication protocol with the specified data frame structure in compliance with the DMX standard (DMX512/1990; United States Institute for Theatre Technology (USITT) standard) is often adopted for transmission of the dimming data.

Besides, in recent years, the RDM (Remote Device Management) standard is also adopted as an extension of the DMX standard. In the RDM standard, a host equipment transmits an inquiring command, and a luminaire receiving this command replies luminaire information to the host equipment. The time of three DMX packets is specified for the inquiry, and next dimming data in compliance with the DMX standard can not be transmitted during the inquiry and reply.

As stated above, when the host equipment acquires the luminaire information of the luminaire, the next dimming data in compliance with the DMX standard can not be transmitted during the inquiry and reply. Thus, there is a fear that the real-time property of light change required for staged dimming can not be secured.

### BRIEF DESCRIPTION OF THE DRAWINGS

FIG. 1 is a block diagram showing a dimming control system of an embodiment.

FIG. 2 is a structural view showing an example of data frames of a communication protocol adopted in the dimming control system.

FIG. 3 is a structural view showing another example of the data frames.

### DETAILED DESCRIPTION

In general, according to one embodiment, a dimming control system includes a luminaire and a host equipment. The luminaire receives dimming data transmitted using data frames based on a specified communication protocol, and performs dimming control of a lighting load. The host equipment uses the data frames to transmit the dimming data, and uses a part of the data frames to transmit a command to request luminaire information of the luminaire.

By this, while the real-time property of staged dimming is secured, the luminaire information from the luminaire is acquired.

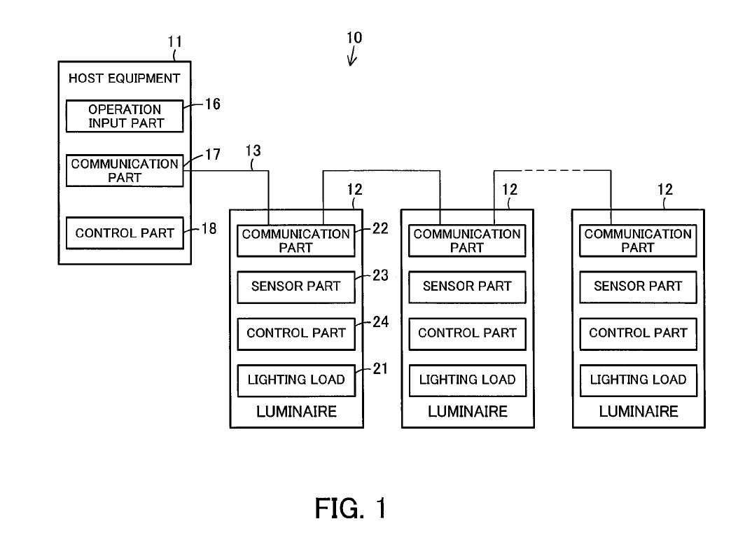

Hereinafter, an embodiment will be described with reference to FIG. 1 to FIG. 3.

As shown in FIG. 1, a dimming control system 10 includes a host equipment 11, luminaires 12 as plural terminals, and a communication line 13 to sequentially connect the plurality of luminaires 12 in series to the host equipment 11 so as to enable communication.

The host equipment 11 is, for example, a dimming operation table, and includes an operation input part 16 including, for example, a feeder and to enable operation input, a communication part 17 to communicate with the luminaire 12 through the communication line 13, and a control part 18 including communication control and to control the host equipment 11.

The luminaires 12 are various luminaires including, for example, a horizon light and a spot light used for the lighting of a stage or a studio.

The luminaire 12 includes a lighting load 21, a communication part 22 to communicate with the host equipment 11 through the communication line 13, a sensor part 23 to acquire luminaire information, and a control part 24 to control the luminaire 12.

The lighting load 21 uses, for example, a light source such as an LED.

The sensor part 23 detects luminaire information including temperature of the lighting load 21, short circuit of the lighting load 21, electric leakage, and other abnormalities.

The luminaire 12 includes ID information intrinsic to each of the luminaires 12, and a channel is arbitrarily set as an intrinsic address for dimming control. A storage part of the control part 24 stores the ID information and the channel information.

In the dimming control system 10, a communication protocol corresponding to, for example, the DMX standard is adopted. The host equipment 11 transmits dimming data, and the luminaire 12 receives the dimming data of its own channel and performs dimming control of the lighting load 21. The host equipment 11 and the luminaire 12 are communicable with each other, and the luminaire 12 can transmit data to the host equipment 11.

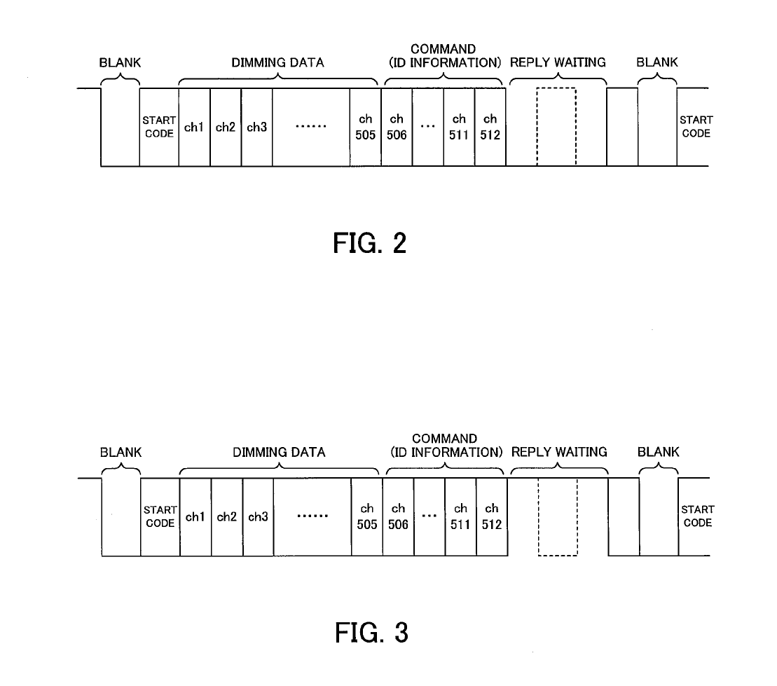

FIG. 2 and FIG. 3 show an example of data frames of the communication protocol adopted by the dimming control system 10. In the DMX standard, a packeted control signal is generated, and the unit of the packet is called a frame. One frame includes 8 bits, the first frame is a start code to specify the kind of the data, and the remaining frames 1 to 512 are data frames. Channels 1 to 512 are allocated to the data frames, and the dimming data is stored for each of the channels 1 to 512. For example, since one channel includes 8 bits, dimming control of 256 gradations can be performed. Further, a start bit and a stop bit as signals for start and stop are added to the first and last of the dimming data of one channel. Accordingly, the dimming data of one channel is sandwiched between the start bit and the stop bit.

Besides, among the channels 1 to 512, all channels are seldom used, that is, the number of the luminaires 12 is often smaller than 512. Thus, among the channels 1 to 512, for example, a data frame of a lower channel is often not used. Incidentally, according to the setting of channels of the luminaires 12, there is a case where a data frame of a higher or medium channel is not used.

The host equipment 11 uses the data frame of the unused channel, and transmits command information requesting the luminaire information to the luminaire 12. For example, when channels including seven lower channels 506 to 512 are not used, the data frames of the channels 506 to 512 are allocated to the command to request the luminaire information of the luminaire 12. The command is ID information of the luminaire 12.

The luminaire 12 confirms whether or not its own ID information is included in the data frames. When its own ID information is included in the data frames, immediately after the transmission completion of the data frames from the host equipment 11 is confirmed, that is, immediately after the stop bit of the last data frame is confirmed, the luminaire transmits the luminaire information detected by the sensor part 23 to the host equipment 11.

The host equipment 11 sets a reply waiting time for receiving the reply from the luminaire 12 in a period from immediately after the transmission of the data frame, that is, from immediately after the stop bit of the last data frame to the transmission of the next data frame. The reply waiting time is a time in a range where a human being can not recognize the change of light, for example, about 10 ms.

As shown in FIG. 2, in the reply waiting time, the output from the host equipment 11 is caused to have a low level, so that the host equipment 11 can receive the signal (indicated by a broken line in FIG. 2) of the luminaire information replied from the luminaire 12. Besides, as shown in FIG. 3, the output from the host equipment 11 in the reply waiting time may be caused to have a high level. In this case, the luminaire 12 side is connected to the signal ground to achieve a low level and transmits the signal (indicated by a broken line in FIG. 3) of the luminaire information, so that the host equipment 11 can receive the luminaire information replied from the luminaire 12.

Next, the operation of the dimming control system 10 will be described.

The host equipment 11 transmits the dimming data to the respective luminaires 12 in accordance with the communication protocol corresponding to the DMX standard, so that the directed lighting state as the stage lighting can be obtained.

Each of the luminaires 12 receives the dimming data of its own channel among the dimming data transmitted from the host equipment 11, and performs dimming control of the lighting load 21.

Besides, when transmitting the dimming data, the host equipment 11 uses the data frames of the unused channels, and transmits the ID information of the specific luminaire 12 from which the luminaire information is requested.

When the specific luminaire 12 confirms that its own ID information is included in the data frames transmitted from the host equipment 11, the luminaire transmits the luminaire information detected by the sensor part 23 to the host equipment 11 immediately after the completion of dimming data transmission is confirmed, that is, immediately after the stop bit of the last data frame is confirmed.

The host equipment 11 receives the luminaire information replied from the luminaire 12 in the reply waiting time from immediately after the dimming data transmission, that is, from immediately after the stop bit of the last data frame to the next dimming data transmission. By this, the host equipment 11 can acquire and confirm the state of the luminaire 12.

Besides, at each time of dimming data transmission, the host equipment 11 changes and transmits the ID information of the luminaire 12 from which the luminaire information is requested, so that the host equipment can acquire the luminaire information of the luminaire 12 from which the luminaire information can be requested.

As stated above, the host equipment 11 uses a part of the data frames to transmit the dimming data and can transmit the command to request the luminaire information of the luminaire 12. Thus, the time for receiving the reply from the luminaire 12 has only to be secured before the next dimming data is transmitted, and the time till the next dimming data transmission can be shortened. Thus, while the real-time property of staged dimming is secured, the luminaire information from the luminaire 12 can be acquired.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A dimming control system comprising:
a luminaire which receives dimming data transmitted using data frames based on a specified communication protocol, and performs dimming control of a lighting load; and
a host equipment which uses the data frames to transmit the dimming data, and uses a part of the data frames to transmit a command to request luminaire information of the luminaire.

2. The system according to claim 1, wherein
the luminaire includes intrinsic ID information, and
the host equipment transmits the ID information of the luminaire as the command.

3. The system according to claim 1, wherein the luminaire receives the command transmitted using the data frame from the host equipment, and replies the luminaire information to the host equipment.

4. The system according to claim 1, wherein
when the luminaire receives the command transmitted from the host equipment using the data frame, the luminaire replies the the luminaire information to the host equipment after reception of the data frame, and
the host equipment receives the luminaire information from the luminaire after transmission of the data frame.

5. The system according to claim 1, wherein the luminaire includes a sensor part to acquire the luminaire information.

6. The system according to claim 5, wherein the sensor part acquires the luminaire information including at least one of temperature of the lighting load, short circuit of the lighting load and electric leakage.

7. The system according to claim 1, wherein
the host equipment allocates a plurality of channels to the data frames, uses the data frame for each of the channels and transmits the dimming data, and
the luminaire includes an intrinsic channel, and receives the dimming data of the relevant channel of the data frame.

8. The system according to claim 1, wherein the host equipment uses the data frame, which is not used for transmission of the dimming data among the data frames, for transmission of the command.

9. The system according to claim 8, wherein the data frame used for the transmission of the command is one of a front side of the data frames, a back side thereof and a middle between the front side and the back side.

10. The system according to claim 1, wherein the host equipment includes a reply waiting time from after transmission of the data frame to next transmission of the data frame, and receives the luminaire information in the reply waiting time.

11. The system according to claim 10, wherein the host equipment causes output from the host equipment to have a low level in the reply waiting time, and receives the luminaire information.

12. The system according to claim 10, wherein
the luminaire replies the luminaire information which is caused to have a low level, and
the host equipment causes output from the host equipment to have a high level in the reply waiting time, and receives the luminaire information.
